(19) United States
(12) Patent Application Publication
(10) Pub. No.: US 2022/0052411 A1
(43) Pub. Date: Feb. 17, 2022

(54) Modular Battery System

(71) Applicant: Cadenza Innovation, Inc., Danbury, CT (US)

(72) Inventors: Joshua LIPOSKY, Seymour, CT (US); Joseph CORRADO, Marlboro, NY (US); Peter A. MANCUSO, Lake Grove, NY (US); Tord Per Jens ONNERUD, Wilton, CT (US)

(73) Assignee: Cadenza Innovation, Inc., Danbury, CT (US)

(21) Appl. No.: 17/297,732

(22) PCT Filed: Nov. 25, 2019
(86) PCT No.: PCT/US19/62967

§ 371 Date: May 27, 2021

Related U.S. Application Data
(60) Provisional application No. 62/772,358, filed on Nov. 28, 2018.

(51) Int. Cl. H01M 50/258; H01M 10/613; H01M 50/505; H01M 50/209

(52) U.S. Cl. CPC H01M 50/258; H01M 10/613; H01M 10/6561; H01M 50/209; H01M 2220/20; H01M 50/505

(57) ABSTRACT

The present disclosure relates to a modular battery system for use in a variety of motive and non-motive applications. The modular battery system further includes at least one module which is configured and dimensioned for receipt of at least one cell. The at least one cell includes a battery cell for providing energy and a supplementary cell for providing ancillary benefits. One aspect of the disclosure incorporates use of supplementary cells in modules for the purposes of adjusting capacity or voltage, while maintaining the desired weight.

### CROSS-REFERENCE TO RELATED APPLICATION

The present application claims priority benefit to a U.S. provisional patent application entitled “Modular Battery System,” which was filed on Nov. 28, 2018, and assigned Ser. No. 62/772,358. The entire content of the foregoing provisional patent application is incorporated herein by reference.

### FIELD OF DISCLOSURE

This disclosure relates to a modular battery system including a battery cell and a supplementary cell.

### BACKGROUND

Lithium ion battery systems are used in a wide array of applications, including energy storage for motive drive and energy storage for stationary systems. These battery systems have modules that incorporate a number of Li-ion cells of varying types, including small cylindrical cells, larger prismatic cells or polymer (or pouch) cells. The capacity and voltage of a system is controlled by connecting the cells in parallel and/or serially within a module. Larger systems have multiple modules, with similar serial or parallel connections and for even larger systems multiple battery packs may be switched into the applications. In order to optimize cost and performance, each serial element of a battery needs to have the same capacity in terms of Ah. Also each string of battery modules or cells in series used in a battery system needs to have the same voltage for safe operation. Depending on the application, these batteries may further have additional mechanical requirements such as geometrical format, weight and weight distribution, and ability to be cooled by air or liquid cooling circuits. The battery systems not only need to provide the functionality of energy storage, but they are also part of the integrated design of the application, such as providing weight for instance for a forklift to not tip over, balance the weight distribution of an electric vehicle, or enabling cooling channels or areas for cooling plates to provide for an even temperature throughout the battery required for long use life and power delivery. To lower cost and provide for flexibility when assembling these battery systems into a variety of formats, solutions are sought that have components with built-in design flexibility. Sought solutions should simplify supply chain operations by minimizing the number of components used, create common manufacturing systems and ultimately lower cost.

Customers of devices using batteries have varying demand For instance, a given battery driven lawnmower product may, for regular home use only, need one or two hours of use and once a week, while a professional user in a landscaping company would require multiple hours on a daily basis. Another example is companies using a forklift of the same type, where one company may only have a few hours of run time requirements per day, while other companies needs forklifts that run 24 hours a day and would pay a premium for longer running batteries.

Many modular lithium ion battery systems and battery modules are known in the art. However, most of the existing battery systems and modules fail to cure several deficiencies once installed within a piece of equipment, such as providing product flexibility in terms of total battery capacity while keeping weight and weight distribution and battery format constant. Another example is allowing a given battery module layout the design flexibility to select between cooling features, such as using either a constant air cooling or liquid cooling circuitry, depending on power and heat removal needs, while keeping a module format constant. Such a solution allows surrounding equipment to keep its original design, as batteries with varying energy storage capacities are deployed, while the battery format and sometimes weight distribution, or center of gravity, needs to be kept constant.

Thus, a need exists for improved modular battery systems that may easily be customized and interchangeably used in equipment while accounting for a minimization of alterations required to the surrounding equipment. Such batteries allow the customer of an application to select batteries with varying run time and hence optimize for low cost depending on the customer's specific application and energy storage needs.

### SUMMARY

The present disclosure relates to a modular battery system (e.g., a pack, a rack) for use in a variety of motive and non-motive applications (e.g., equipment/system). At least one pack (e.g., battery pack) may be utilized, however, additional battery packs may be utilized depending on the scope of the application. The disclosed battery pack may include at least one module positioned therein. The disclosed battery pack may, at least in part, be utilized as an energy source. In some instances, the disclosed module(s) may, at least in part, be utilized as an energy source (e.g., battery module). The disclosed module(s) may, at least in part, be utilized for a non-energy source (e.g., supplementary module or a supplementary battery cell). The disclosed module(s) may be configured and dimensioned for semi-permanent integration within the disclosed battery pack, so modules or battery cells may be easily replaced or configured within the format. One example is when using the same module geometry for one or more cells. The disclosed module(s) may be removably integrated within the disclosed battery pack such that individual module(s) may be replaced with a non-active element of the same formfactor without disrupting the function(s) of the disclosed battery pack. The disclosed module(s) may further include at least one cell positioned therein. The disclosed cell(s) may be configured and dimensioned for semi-permanent integration within the disclosed module(s). The disclosed cell(s) may be removably integrated within the disclosed module(s) such that the individual cell(s) may be replaced without disrupting the function(s) of either the disclosed battery pack or the disclosed module(s). One example of such a function being kept constant may be to maintain the center of mass or maintaining the same voltage level for a lesser capacity, while keeping weight constant.

As used herein, equipment and system may be used interchangeably. Motive and non-motive equipment may include, but is not limited to, manned/unmanned lifting equipment (e.g., scissor lift, boom lift, atrium lift, crane/boom truck); air compressors; air handler/chiller; compaction equipment (e.g., tamper, vibratory compactor, roller); mixing equipment (e.g., concrete mixing equipment); earth moving equipment (e.g., crawler, backhoe, loader, bulldozer, tractor, excavator); maintenance and cleaning equipment (e.g., pressure washer, floor sweeper, floor scrubber, ice resurfacer, vacuum, floor buffer, carpet extractor, abrasive blaster); material handling equipment (e.g., forklift, crane, winch, hoist, jack); lighting equipment (e.g., light tower, light stand); traffic safety equipment (e.g., arrow/message board, traffic signal); generator (e.g., portable generator, stationary generator); lawn care equipment (e.g., grinder, seed spreading equipment, chipper, mower, snow blower, snow thrower); load bank; paving equipment; pumps; air conditioner; dehumidifier; heater; automobile; energy storage system (e.g., power grid); Off-road vehicle (e.g., all-terrain vehicle, three-wheeler, four-wheeler, six-wheeler, utility vehicle); two-wheeler (e.g., scooter, moped, motorcycle); marine equipment (e.g., boat, personal water craft, submarine); aircraft, airship (e.g., blimp); welding equipment; appliances (e.g., refrigerator, stove, oven, microwave); and any combination thereof. Batteries for these type equipment are sometimes referred to as industrial batteries.

Note, it is conceivable (and expected) that some of the above-listed equipment may be utilized for multiple purposes. In such case, the above list is not intended to be limiting such that the exemplary equipment is limited to its noted purpose. Also, it is conceivable (and expected) that some of the above-listed equipment may be referred to by multiple names. In such case, the above list is not intended to be limiting such that the exemplary equipment is limited to the name described above, but rather the above-listed equipment is expected to provide non-limiting examples of the potential areas of use for the modular battery system.

The at least one battery pack may be incorporated into or in close proximity to the disclosed equipment. The disclosed battery pack(s) may be retrofitted to the disclosed equipment such that the at least one battery pack replaces or supplements the existing drive mechanisms. The disclosed battery pack(s) may be initially designed to be incorporated into or in close proximity to the disclosed equipment. The battery pack(s) may also be permanently installed into the equipment without a need to be replaced.

In an exemplary embodiment, the disclosed battery pack(s) may include at least one module. The disclosed battery pack(s) may include a plurality of modules. The at least one module may include at least one battery cell, at least one non-battery cell (“supplementary cell”), or at least one battery cell and at least one supplementary cell. The at least one module may include a plurality of battery cells, a plurality of non-battery cells (“supplementary cells”), or a plurality of battery cells and a plurality of supplementary cells. Such supplementary cells having a form factor designed to match the battery cell geometry for mounting purposes. In some instances, the disclosed cell(s) may, at least in part, be utilized as an energy source (“battery cell”). The quantity of battery cells may be determined, at least in part, based on the required energy density to at least partially operate the disclosed equipment. In some embodiments, the disclosed battery cell may be a lithium ion battery. In an exemplary embodiment, the disclosed battery cell may resemble the lithium ion battery disclosed in U.S. Pat. Nos. 9,685,644 and 9,871,236, the content of the foregoing patents are incorporated herein by reference.

The disclosed supplementary module and/or supplementary cell may be a functional or non-functional element. For example, the disclosed supplementary module and/or supplementary cell may include, but not limited to, a cooling element (e.g., heat sink); a non-functional weight (“ballast”); a functional weight; a control system module; a shock absorbing element; a fusing and switch element; an inverter; a thermal compliance device; and any combination thereof. A functional weight is a weight that has at least one more function than pure mass.

In an exemplary embodiment, the at least one pack may be configured and dimensioned to be incorporated into or in close proximity to at least one of the disclosed equipment. Analysis of the equipment may occur prior to configuring the disclosed pack(s). For example, in the case where the disclosed pack(s) is replacing an existing power source contributing to the mechanical properties of the equipment (e.g., retrofit or new build) a plurality of parameters may be measured/calculated so as to characterize the equipment, in such a way that performance can be maintained without changing surrounding equipment to the power source (the battery). For example, the weight, the required energy density and the space constraints of the equipment may be measured/calculated. In response, the disclosed pack(s) may be designed to ensure comparable performance/size.

For example, the disclosed pack(s) may be constructed with at least one module including at least one battery cell. The disclosed pack(s) may be constructed with at least one module including a plurality of battery cells. The disclosed pack(s) may be constructed with at least one module including a plurality of battery cells and including at least one supplementary cell. In some instances, the supplementary module and/or supplementary cell may compensate for the shortcomings of the disclosed battery modules and/or battery cells so as to ensure the disclosed pack(s) achieve comparable or improved performance in comparison to existing equipment. For example, in the instance where the disclosed pack(s) having at least one module with a plurality of battery cells is unable to achieve the desired weight, at least one supplementary module and/or supplementary cell may be incorporated.

In another example, if the design intent of existing equipment were characterized having a weight of X and an energy density of Y, the disclosed pack(s) would be designed to at least replicate X and Y or potentially enhance X and/or Y, while ensuring the disclosed pack(s) fits within a predetermined size. To achieve this balance, a formula may be created to calculate the required parameters of the disclosed pack(s) by accounting for the parameters of the existing equipment. Such balance may include incorporating at least one battery module and, optionally, at least one supplementary module. Such balance may further include incorporating at least one battery module and at least one supplementary module. Additionally, on a cellular level, at least one module may include at least one battery cell and, optionally, at least one supplementary cell. The disclosed pack(s) may further include a plurality of modules, wherein a plurality of battery cells are incorporated therein and, optionally, at least one supplementary cell is also incorporated therein. The disclosed pack(s) may further include a plurality of modules, wherein a plurality of battery cells are incorporated therein and at least one supplementary cell is also incorporated therein.

In another example, if the disclosed equipment required a design having a specific weight and varying energy density to fill a desired battery space, the disclosed pack(s) may be designed to at least replicate the geometrical and weight requirements, and minimum power requirements. In some instances, the disclosed pack(s) may achieve the desired energy density, but the weight of the pack(s) is less than required, thereby improving on a minimized weight requirement. In some applications, the reduction in weight may affect the counterbalance of the equipment (e.g., a forklift). Therefore, at least one supplementary module and/or supplementary cell may be integrated into the disclosed pack(s)/module(s). However, any one of the disclosed supplementary modules/cells may supplement the disclosed pack(s). In some instances, at least two different types of supplementary modules/cells may be incorporated into the disclosed pack(s). For example one of the modules could be supplementary as to weight, while another module may be supplementary as to incorporate a cooling function. Still, all the modules have the same format, so that they will fit within the enclosure and can be mounted using the same mechanisms.

In another exemplary embodiment, the disclosed module(s) may be positioned relative to at least one rack. For example, the disclosed module(s) may be positioned within a vertical rack or a horizontal rack. For example, the disclosed modules may be positioned within a rack (e.g., vertical or horizontal) on a plurality of levels. The disclosed rack may include at least one module per level. The disclosed rack may include a plurality of modules per level.

The at least one rack may be incorporated into or in close proximity to the disclosed equipment. The disclosed rack(s) may be retrofit to the disclosed equipment such that the at least one rack replaces or supplements the existing design intent of the equipment. The disclosed rack(s) may be initially designed to be incorporated into or in close proximity to the disclosed equipment.

In another exemplary embodiment, the disclosed battery cells positioned within the disclosed module(s) may be electrically connected so that all utilize a parallel connection, all utilize a serial connection, or a combination of parallel and serially connected battery cells. In another exemplary embodiment, the disclosed modules may be electrically connected in a parallel connection, a serial connection, or a combination of parallel and serially connected battery modules.

Any combination or permutation of embodiments is envisioned. Additional advantageous features, functions and applications of the disclosed systems, methods and assemblies of the present disclosure will be apparent from the description which follows, particularly when read in conjunction with the appended figures. All references listed in this disclosure are hereby incorporated by reference in their entireties.

### BRIEF DESCRIPTION OF THE FIGURES

The invention will be better understood on reading the description which follows, given solely by way of non-limiting example and made with reference to the drawings in which:

FIG. 1A depicts a projection view of an advantageous battery pack according to the present disclosure;

FIG. 1B depicts a projection view with a section removed for clarity of an advantageous battery pack according to the present disclosure;

FIG. 2 depicts a projection view of an advantageous module according to the present disclosure;

FIG. 3 depicts a projection view of an advantageous module according to the present disclosure;

FIG. 4A depicts a side view of an advantageous clip assembly according to the present disclosure;

FIG. 4A depicts a projection view of an advantageous clip assembly according to the present disclosure;

FIG. 5 depicts a projection view of an advantageous battery pack according to the present disclosure;

FIG. 6 depicts a projection view of an advantageous battery pack according to the present disclosure;

FIG. 7 depicts a projection view of an advantageous battery rack according to the present disclosure;

FIG. 8 depicts a projection view of an advantageous battery rack according to the present disclosure;

FIG. 9 depicts a projection view of an advantageous battery rack according to the present disclosure;

FIG. 10 depicts a projection view of an advantageous module according to the present disclosure;

FIG. 11 depicts a projection view of an advantageous module with cells according to the present disclosure;

FIG. 12 depicts a projection view of an advantageous cell blocks according to the present disclosure;

FIG. 13 illustrates the air flow across an advantageous module according to the present disclosure; and

FIG. 14 depicts an exploded projection view of an advantageous control module according to the present disclosure.

### DETAILED DESCRIPTION

Reference will now be made in detail to embodiments of the disclosure, which are illustrated in the accompanying figures and examples. Referring to the drawings in general, it will be understood that the illustrations are for the purpose of describing particular embodiments of the disclosure and are not intended to limit the same. The use of any orientation labels (e.g., side, back or front) are not intended to be limiting, but rather to provide descriptors for ease of explanation. The use of any quantities are not intended to be limiting, but rather as exemplary embodiments for ease of explanation and to assist one skilled in the art to make/use the disclosed modular battery system.

Whenever a particular embodiment of the disclosure is said to comprise or consist of at least one element of a group and combinations thereof, it is understood that the embodiment may comprise or consist of any of the elements of the group, either individually or in combination with any of the other elements of that group.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

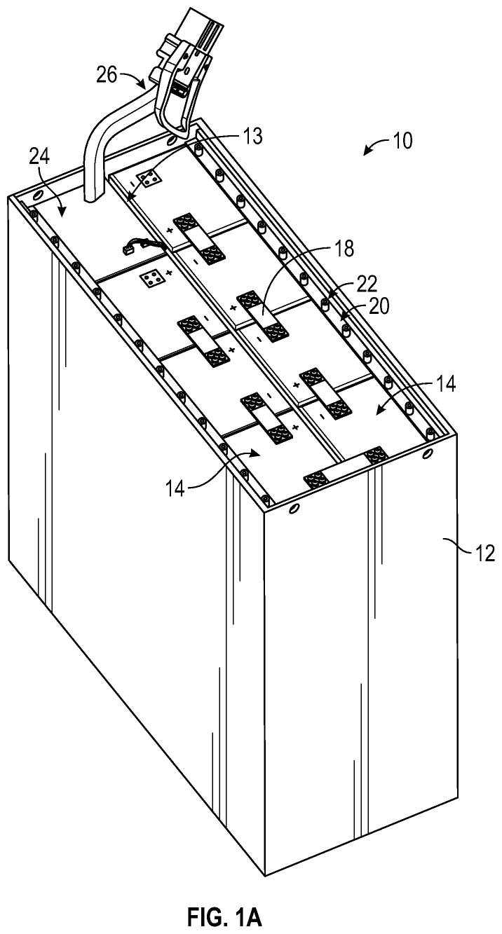

As depicted in FIGS. 1A and 1B, modular battery system (e.g., a pack, a rack) 10 may be utilized in a variety of motive and non-motive applications (e.g., equipment/system). At least one pack (e.g., battery pack) 10 may further include at least one module 14 positioned within cavity 13 of case 12. Pack 10 may further include a cover (not shown) to engage with case 12. Case 12 and cover (not shown) may be fabricated from plastic, ceramic, metal and any combination thereof. Battery pack 10 may include a plurality of modules 14. The quantity of module(s) 14 is at least partially determined based on the specifications of a particular application. The dimensions of case 12 may be scaled to accommodate the desired quantity of modules 14. In an exemplary embodiment, battery pack 10 may include at least 2 modules. Battery pack 10 may be configured and dimensioned to accept 8 modules 14. In some embodiments, as depicted in FIGS. 1A and 1B, battery pack 10 may include 7 modules and one electrical management system 24. Electrical management system 24 may further include wiring harness 26, which electrically connects control circuitry between module(s) 14. Battery pack 10 having 7 serially connected modules 14 may produce a voltage of about 24 Vdc.

Module(s) 14 may, at least in part, be utilized as an energy source (e.g., battery module). Module(s) 14 may, at least in part, be utilized as a non-energy source (e.g., supplementary module). Module(s) 14 may be removably integrated within battery pack 10 such that individual module(s) 14 may be replaced without disrupting the function(s) of battery pack 10. In an exemplary embodiment, battery module 14 and supplementary module 14 may have nearly identical dimensions such that modules 14 are interchangeable.

Battery module(s) 14 may be electrically connected in a parallel connection, a serial connection, or a parallel connection of a first set of module(s) 14, a parallel connection of a second set of module(s) 14, and a serial connection of the first set of module(s) 14 and the second set of module(s) 14. It should be understood that a “set” may refer to at least one module 14. Battery module(s) 14 may have individual voltage levels. Battery module(s) 14 may be electrically connected by bus bar 18. Bus bar 18 may electrically connect at least two modules 14. Bus bar 18 may be positioned relative to lid 110 of module 14. Bus bars 18 may electrically connect module(s) 14 such that electrical management system 24 is electrically connected to the desired module(s) 14.

Module(s) 14 may be mounted with respect to at least one sidewall of case 12. For example, lid 110 of module(s) 14 may be mounted with respect to L-shaped bar 20, which is mounted with respect to case 12. At least one fastener 22 may engage with hole 112 of lid 110. Module(s) 14 may be configured and dimensioned for semi-permanent integration within case 12. Module(s) 14 may be removably integrated within case 12 such that individual module(s) 14 may be replaced without disrupting the function(s) of battery pack 10.

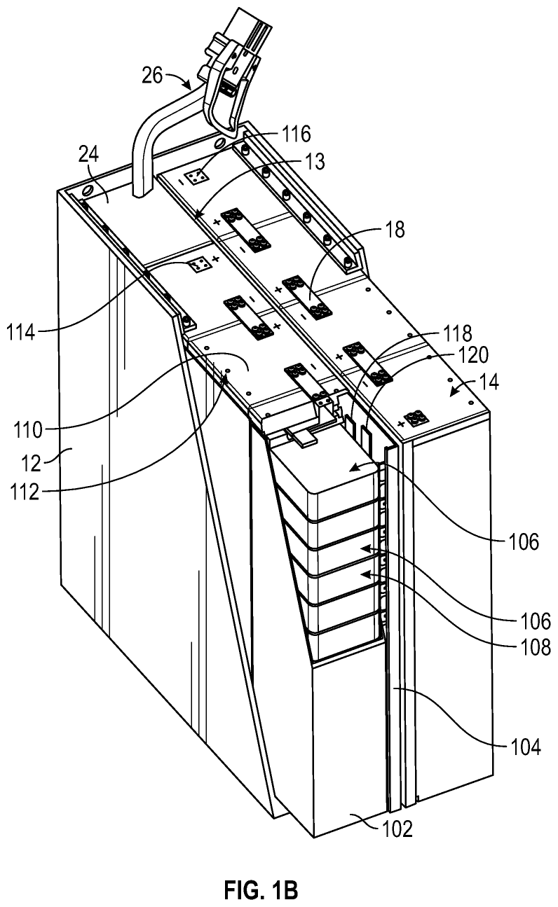

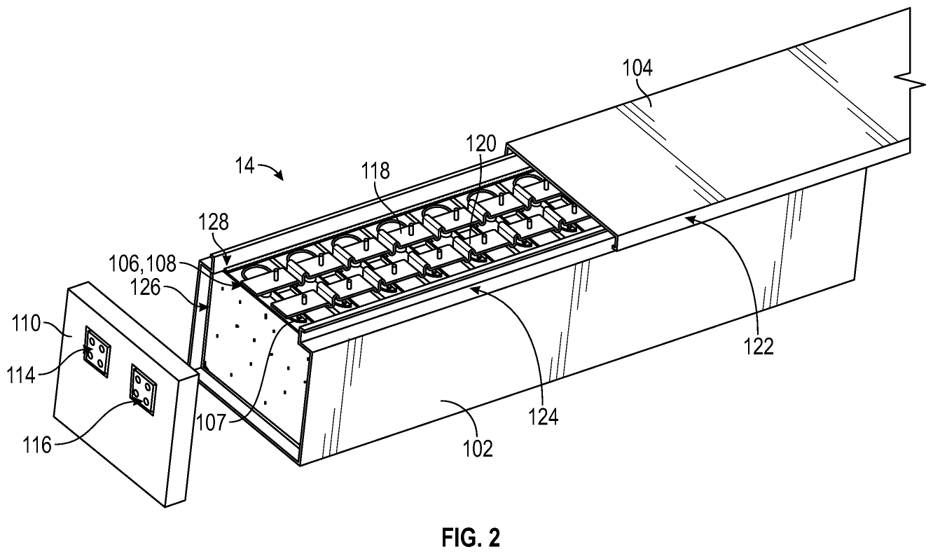

Module(s) 14 may further include at least one cell 106, 108 positioned therein, as further depicted in FIGS. 2 and 3. The at least one module 14 may include at least one battery cell 106, at least one non-battery cell (“supplementary cell”) 108, or at least one battery cell 106 and at least one supplementary cell 108. The at least one module 14 may include a plurality of battery cells 106, a plurality of supplementary cells 108, or a plurality of battery cells 106 and a plurality of supplementary cells 108. The at least one cell 106, 108 may be configured and dimensioned for semi-permanent integration within module(s) 14. Cell(s) 106, 108 may be removably integrated within module(s) 14 such that the individual cell(s) 106, 108 may be replaced without disrupting the function(s) of either battery pack 10 or module(s) 14. Cells 106, 108 may have nearly identical dimensions such that cells 106, 108 are interchangeable.

Battery cell 106 may, at least in part, be utilized as an energy source. The quantity of battery cells 106 may be determined, at least in part, based on the required energy density to at least partially operate the disclosed equipment. In some embodiments, battery cell 106 may be a lithium ion battery. In another exemplary embodiment, battery cells 106 positioned within module(s) 14 may all be electrically connected in a parallel connection, all serially connected, or a combination of serial and parallel battery cells 106

Module 14 includes module enclosure 102 and module cover 104, which is positioned in close proximity to module enclosure 102. Module enclosure 102 may define a U-shaped cavity which extends at least partially the length of module enclosure 102. Module enclosure 102 may be configured and dimensioned to engage with at least one cell 106, 108. Module enclosure 102 and module cover 104 may be movably engaged. Module enclosure 102 may include L-shaped cavity 124 which is configured and dimensioned for at least partial receipt of engagement surface 122 of module cover 104. Engagement of L-shaped cavity 124 and engagement surface 122 inhibits movement of module enclosure 102 and module cover 104 to one plane. Particularly, engagement of L-shaped cavity 124 and engagement surface 122 permits slidable engagement of module enclosure 102 and module cover 104. Further, lid 110 may be positioned relative to module enclosure 102 and/or module cover 104. Lid 110 may be positioned with respect to engaged module enclosure 102 and module cover 104. Lid 110 may be positioned at least partially within U-shaped cavity of module enclosure 102. Lid 110 may at least partially encapsulate cells 106, 108 within module enclosure 102.

In an exemplary embodiment, at least one cell 106, 108 is positioned within modular enclosure 102. Cell(s) 106, 108 may movably positioned within modular enclosure 102. Cell(s) 106, 108 may be slidably positioned within modular enclosure 102. Cell(s) 106, 108 may be at least partially constrained by L-shaped cavity 124. Particularly, L-shaped cavity 124 may at least partially cover top surface 107 of cell(s) 106, 108. Insulator 126 may be positioned between cell(s) 106, 108 and module enclosure 102. Insulator 126 may be an electrical and/or vibrational liner. Insulator 126 may be positioned below L-shaped cavity 124 such that insulator is at least partially in contact with top surface 107 of cell(s) 106, 108.

Cells 106, 108 may be electrically connected by bus bars 118, 120. Bus bars 118, 120 may be electrically connected to cells 106, 108 in a parallel or serial configuration. FIG. 2 depicts cells 106, 108 in a parallel configuration. Bus bars 118, 120 may electrically engage with lid 110. Specifically, bus bars 118, 120 may electrically engage with terminals 114, 116 positioned with respect to lid 110. In an exemplary embodiment, bus bar 118 is electrically connected to the positive connectors of cells 106, 108 and bus bar 120 is electrically connected to the negative connectors of cells 106, 108. In such case, bus bar 118 would be electrically connected to positive terminal 114 and bus bar 120 would be electrically connected to negative terminal 116. Lid 110 may further include at least one fuse. Although supplementary cell 108 is not a battery, it may benefit from being electrically connected to bus bars 118, 120. For example, supplementary cell 108 may include an electrical component, as described herein, that may be powered from bus bars 118, 120.

Module 14 may include a plurality of parallelly connected battery cells 106. Module 14 having a plurality of parallelly connected battery cells 106 may be serially connected to at least one more module 14 having a plurality of parallelly connected battery cells 106. A plurality of modules 14, each having a plurality of parallelly connected battery cells 106, may be serially connected. At least one battery cell 106 may be replaced with at least one supplementary cell 108. In an exemplary embodiment, module 14 may include 12 parallelly connected battery cells 106. Module 14 having 12 parallelly connected battery cells 106 may be serially connected to at least one more module 14 having 12 parallelly connected battery cells 106. 7 modules 14, each having 12 parallelly connected battery cells 106, may be serially connected.

In another exemplary embodiment, as depicted in FIG. 1B, module 14 may include at least one battery cell 106 and at least one supplementary cell 108. Battery cell 106 and supplementary cell 108 may be interchangeably replaced based on the desired parameters (e.g., increased weight, increased energy density, decrease weight, decrease energy density). At least one supplementary cell 108 may replace at least one battery cell 106 without affecting the operability of the remaining battery cells 106, module 14 or pack 10. In another example, at least one battery module 14 may be replaced by at least one supplementary module 14.

Module 14 may further include cell control management 202. Cell control management 202 may replace lid 110 or may be integrated with lid 110 such that cell control management 202 and the disclosed terminals and fuse(s) are combined. Cell control management 202 may operate module 14 in accordance with provided direction so as to ensure safe operation of cells 106, 108 within module 14.

Module 14 may also include at least one temperature module 204 positioned in close proximity to at least one cell(s) 106, 108, as depicted in FIG. 3. Module 14 may include a plurality of temperature modules 204. Temperature module 204 may be positioned between each cell 106, 108. Temperature module 204 may be utilized to increase or decrease the temperature of module 14 and/or at least one cell 106, 108. Temperature module 204 may be configured and dimensioned to accept a liquid with sufficient thermal conductivity. In some embodiments, temperature module 204 may be a cooling module. In another embodiment, temperature module 204 may be a heating module.

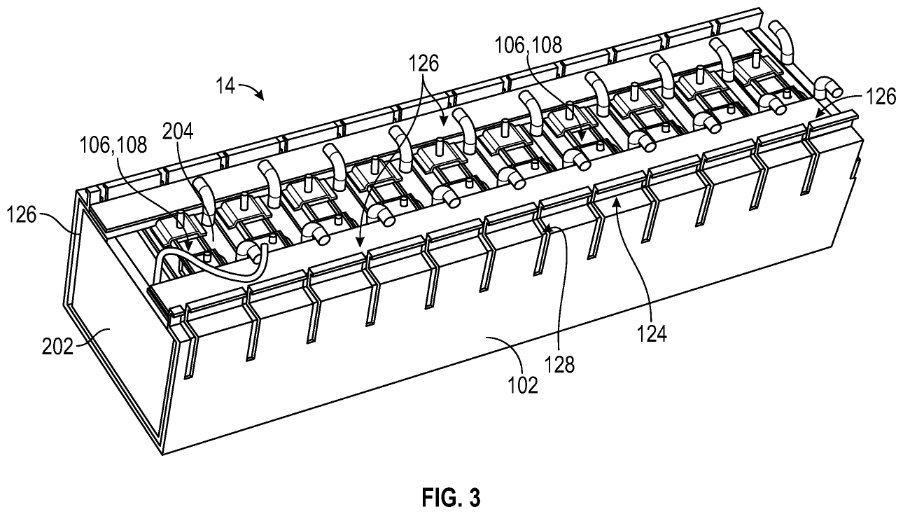

In an exemplary embodiment, as depicted in FIGS. 4A and 4B, cells 106, 108 may be at least partially constrained by clip assembly 254. Clip assembly 254 may be positioned within cavity 252. Clip assembly 254 may engage with interior wall 130 of L-shaped cavity 124. Clip assembly 254 may include base 256 which may extend at least partially the length of module enclosure 102. Base 256 may further include at least one foldable tab 258 configured and dimensioned to fold along score line 260 and to at least partially retain cell 106, 108. For example, foldable tab 258 may engage insulator 126 which, in turn, may apply some pressure to cell 106, 108. In another instance, foldable tab 258 may engage directly with cell 106, 108. Foldable tab 258 may be adjustably configured to retain cell 106, 108. For example, engagement of fastener 264 against foldable tab 258 directs foldable tab 258 further away from interior wall 130. Fastener 264 may be positioned through L-shaped cavity 124 and configured to interact with engagement hole 262 of foldable tab 258.

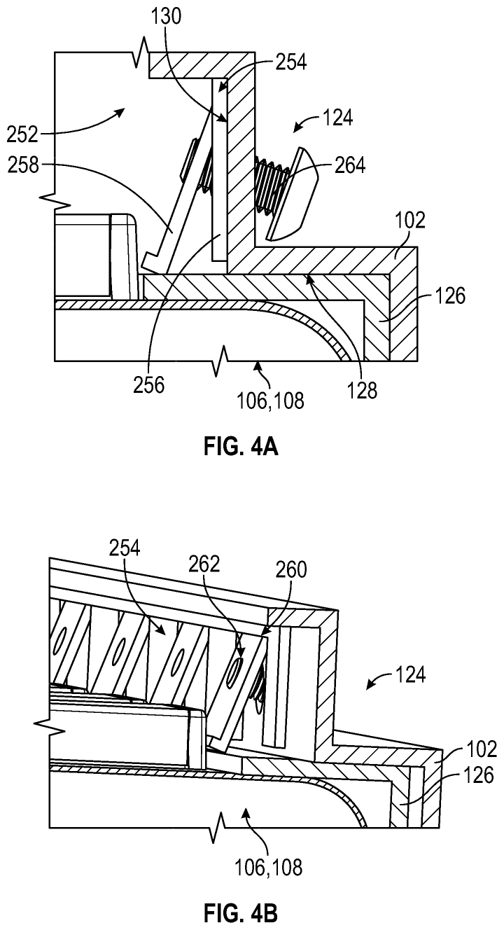

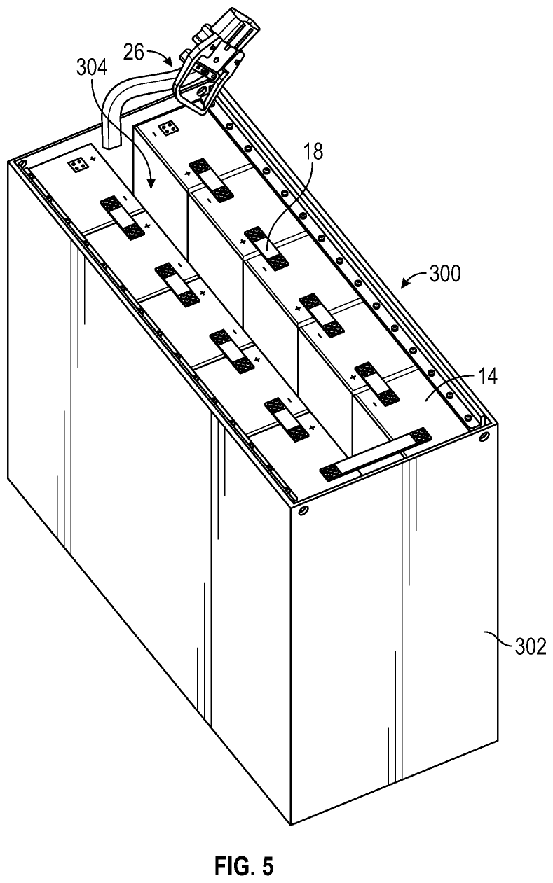

As stated above, the disclosed pack(s) may be constructed with a plurality of modules 14. FIGS. 5 and 6 depict two exemplary pack assemblies 300, 400 having additional modules 14. The explanation pertaining to pack 10 pertains entirely to packs 300, 400. Therefore, the above discussion is incorporated herein with regards to packs 300, 400. In an exemplary embodiment, pack 300 includes a plurality of modules 14 positioned within cavity 304 of case 302. Battery pack 300 may be configured and dimensioned to accept at least 10 modules 14 and one wiring harness 26. As stated above, modules 14 may be a combination of battery modules 14 and supplementary modules 14. Battery pack 300 having 10 serially connected modules 14 may produce a nominal voltage of about 36 Vdc. As stated previously, modules 14 are interchangeable.

In another exemplary embodiment, pack 400 includes a plurality of modules 14 positioned within cavity 404 of case 402. Battery pack 400 may be configured and dimensioned to accept at least 14 modules 14 and one wiring harness 26. As stated above, modules 14 may be a combination of battery modules 14 and supplementary modules 14. Battery pack 400 having 14 serially connected modules 14 may produce a nominal voltage of about 48 Vdc. As stated previously, modules 14 are interchangeable.

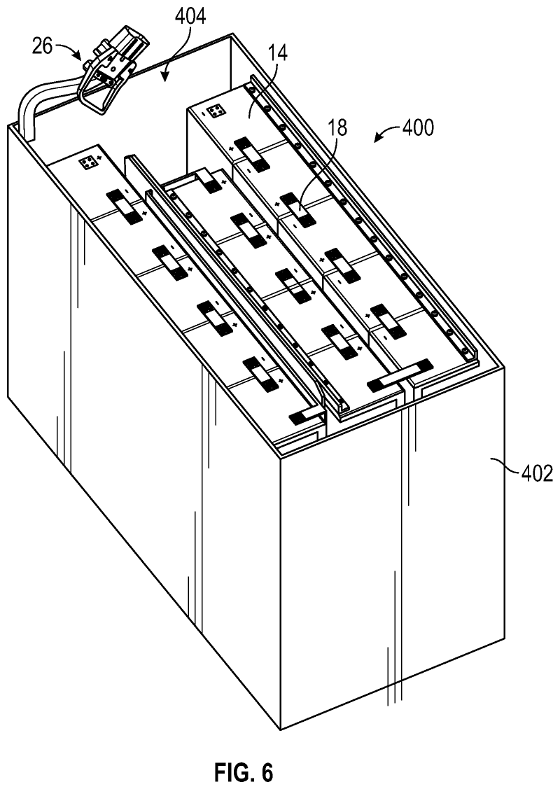

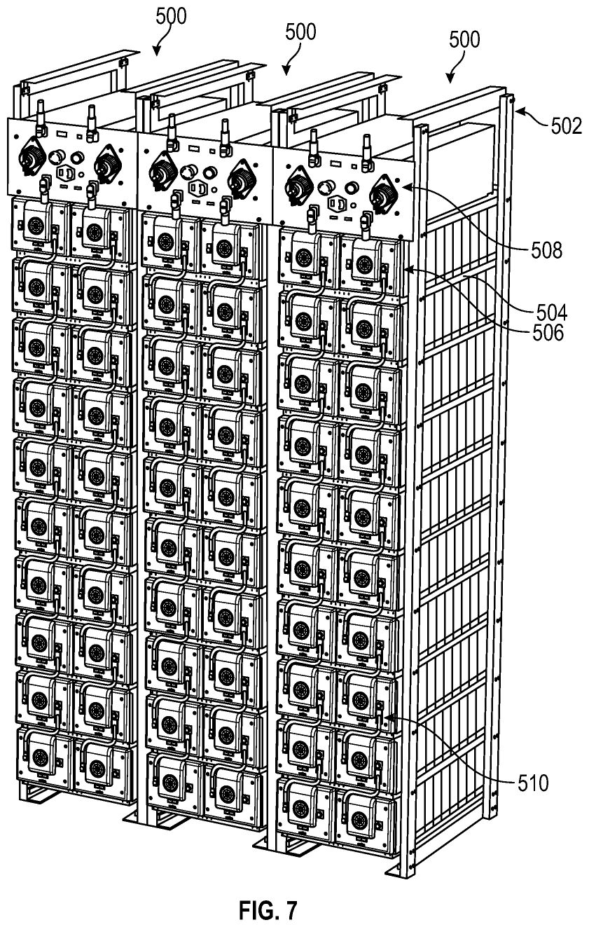

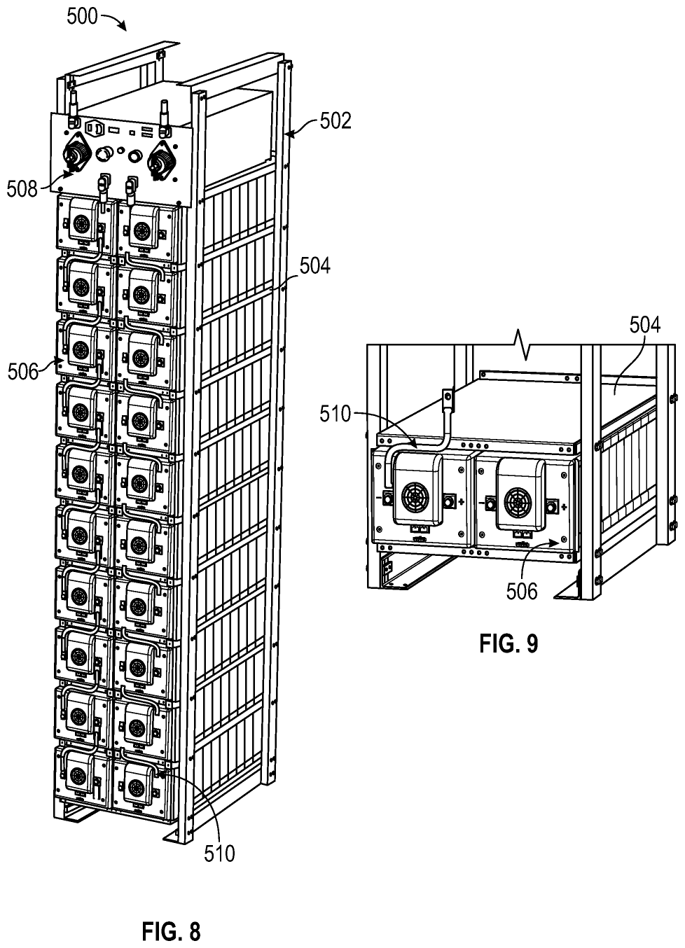

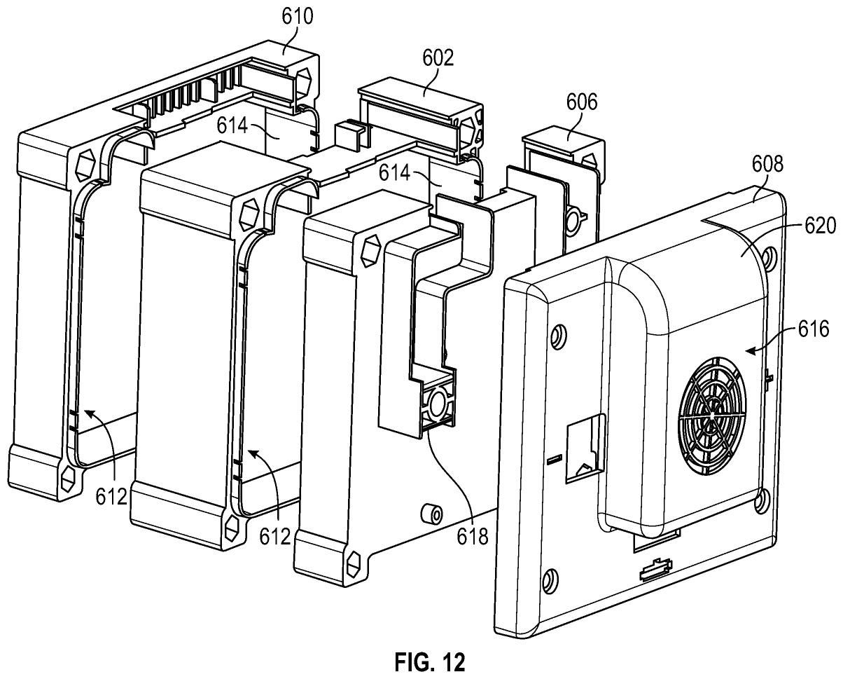

In another exemplary embodiment, as illustrated in FIGS. 7-14, modular battery system (e.g., a rack, a pack) 500 may be utilized in a variety of motive and non-motive applications (e.g., equipment/system). At least one rack (e.g., battery rack) 500 may further include at least one module 506 positioned within rack assembly 502. Rack 500 may further include at least one shelf 504 configured and dimensioned to engage with module 506. Rack 502 may be fabricated from plastic, ceramic, metal and any combination thereof. Battery rack 500 may include a plurality of modules 506. The quantity of module(s) 506 is at least partially determined based on the electrical and mechanical specifications of a particular application. The dimensions of rack assembly 502 may be scaled to accommodate the desired quantity of modules 506. In an exemplary embodiment, battery rack 500 may include at least 2 modules.

Battery rack 500 may be configured and dimensioned to accept 20 modules 506. Battery rack 500 may further include control module 508 positioned relative to rack assembly 502. In some embodiments, battery rack 500 may be electrically connected with adjacent battery racks 500, as depicted in FIG. 7.

Module(s) 506 may, at least in part, be utilized as an energy source (e.g., battery module). Module(s) 506 may, at least in part, be utilized as a non-energy source (e.g., supplementary module). Module(s) 506 may be removably integrated within battery rack 500 such that individual module(s) 506 may be replaced without disrupting the function(s) of battery rack 500. In an exemplary embodiment, battery module 506 and supplementary module 506 may have nearly identical dimensions such that modules 506 are interchangeable.

Battery module(s) 506 may be electrically connected in a parallel connection, a serial connection, or a parallel connection of a first set of module(s) 506, a parallel connection of a second set of module(s) 506, and a serial connection of the first set of module(s) 506 and the second set of module(s) 506. It should be understood that a “set” may refer to at least one module 506. Battery module(s) 506 may have individual voltage levels. Battery module(s) 506 may be electrically connected by bus bar 510. Bus bar 510 may electrically connect at least two modules 506. Bus bar 510 may be coated with a non-conductive material. Bus bars 510 may electrically connect module(s) 506 such that control module 508 is electrically connected to the desired module(s) 506.

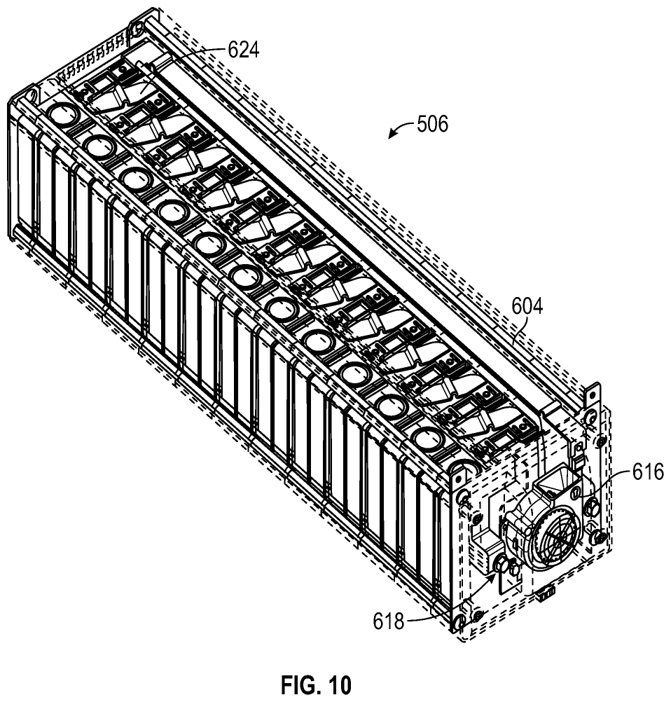

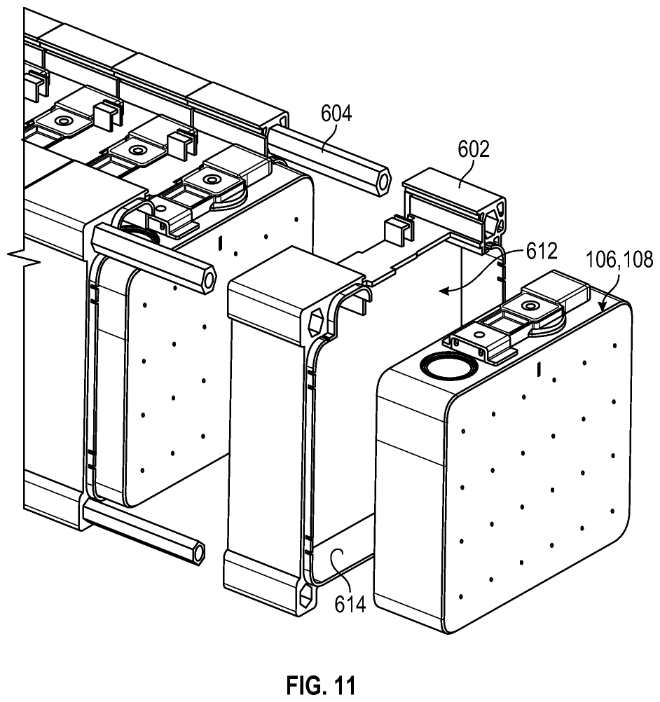

Module(s) 506 may further include at least one cell 106, 108 positioned therein, as further depicted in FIGS. 10 and 11, and as discussed herein. The at least one module 506 may include at least one battery cell 106, at least one non-battery cell (“supplementary cell”) 108, or at least one battery cell 106 and at least one supplementary cell 108. The at least one module 506 may include a plurality of battery cells 106, a plurality of supplementary cells 108, or a plurality of battery cells 106 and a plurality of supplementary cells 108. The at least one cell 106, 108 may be configured and dimensioned for semi-permanent integration within module(s) 506. Cell(s) 106, 108 may be removably integrated within module(s) 506 such that the individual cell(s) 106, 108 may be replaced without disrupting the function(s) of either battery rack 500 or module(s) 506. Cells 106, 108 may have nearly identical dimensions such that cells 106, 108 are interchangeable.

Battery cell 106 may, at least in part, be utilized as an energy source. The quantity of battery cells 106 may be determined, at least in part, based on the required energy density and voltage to operate the disclosed equipment. In some embodiments, battery cell 106 may be a lithium ion battery. In another exemplary embodiment, battery cells 106 positioned within module(s) 506 may be electrically connected in a parallel connection, a serial connection, or a combination of parallel and serial connections.

It should be understood that module 14, described above, and module 506 may be used interchangeably for either battery pack 10 or battery rack 500. Therefore, although module 14 is discussed solely with reference to battery pack 10 and module 506 is discussed solely with reference to battery rack 500, it should be understood that any of the disclosed features may be used within either module 14 or module 506.

Module 506 defines a nestable configuration including at least one retention block 602 configured and dimensioned to at least partially engage with cell 106, 108, as depicted in FIGS. 10-12. Module 506 may further include terminal block 606 positioned relative to front block 608. Module 506 may further include end block 510 positioned opposite front block 608. Blocks 602, 606, 608, 610 may be configured and dimensioned to engage in a snap-fit configuration. In another embodiment, module 506 may include at least one retention rod 604 positioned relative to block 602, 606, 608, 610. Block 602, 606, 610 may include at least one cavity 612 which is configured and dimensioned to at least partially engage with cell 106, 108. Cavity 612 is at least partially defined by sidewalls 614, which are configured and dimensioned to at least partially engage with cell 106, 108. Cavity 612 and sidewalls 614 may at least partially encapsulate cell 106, 108. In an exemplary embodiment, blocks 602, 606, 608, 610 may be slidably engaged with rod 604. Module 506 may further include at least one insulator (not shown) which may be positioned in close proximity to cell(s) 106, 108. Insulator (not shown) may be an electrical and/or vibrational liner.

Cells 106, 108 may be electrically connected by bus bars 624. Bus bars 624 may be electrically connected to cells 106, 108 in a parallel or serial configuration. FIG. 10 depicts cells 106, 108 in a serial configuration. Bus bars 624 may be electrically engaged with terminal 618 of terminal block 606. Terminal 618 electrically connects modules 506 to bus bar 510. Terminal block 606 may further include at least one fuse. Although supplementary cell 108 is not a battery, it may benefit from being electrically connected to bus bars 624. For example, supplementary cell 108 may include an electrical component, as described herein, that may be powered from bus bars 624.

Module 506 may include a plurality of serially connected battery cells 106. Module 506 having a plurality of serially connected battery cells 106 may be serially connected to at least one more module 506 having a plurality of serially connected battery cells 106. A plurality of modules 506, each having a plurality of serially connected battery cells 106, may be serially connected. At least one battery cell 106 may be replaced with at least one supplementary cell 108. In an exemplary embodiment, module 506 may include 12 serially connected battery cells 106. Module 506 having 12 serially connected battery cells 106 may be serially connected to at least one more module 506 having 12 serially connected battery cells 106. Battery rack 500 may include 20 serially connected modules 506, each having 12 serially connected battery cells 106.

In another exemplary embodiment, module 506 may include at least one battery cell 106 and at least one supplementary cell 108. Battery cell 106 and supplementary cell 108 may be interchangeably replaced based on the desired parameters (e.g., increased weight, increased energy density, decrease weight, decrease energy density). At least one supplementary cell 108 may replace at least one battery cell 106 without affecting the operability of the remaining battery cells 106, module 506 or rack 500. In another example, at least one battery module 506 may be replaced by at least one supplementary module 506.

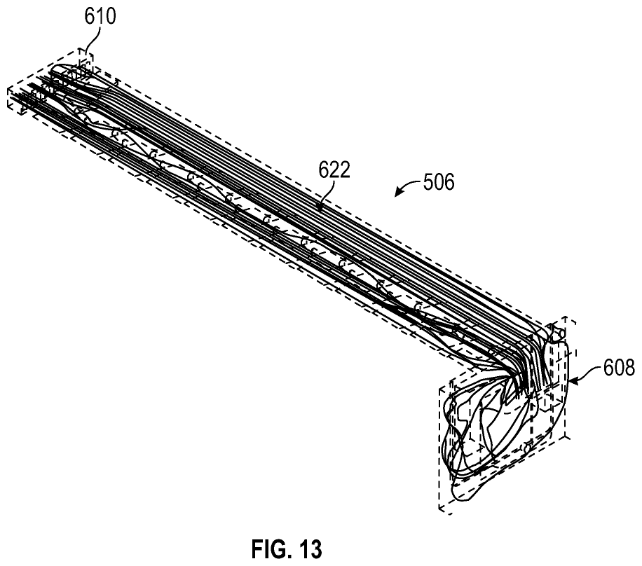

Module 506 may further include front block 608 which at least partially engages with terminal block 606. Front block 608 may further include cooling device (e.g., a fan) 616 and a shroud 620 for directing air flow 622 across the plurality of cells 106, 108, as depicted in FIG. 13. End block 610 is configured and dimensioned to redirect air flow 622 towards cooling device 616 so as to circulate air flow 622.

Module 506 may also include at least one temperature module (not shown) positioned in close proximity to at least one cell(s) 106, 108. Module 506 may include a plurality of temperature modules (not shown). Temperature module (not shown) may be positioned between each cell 106, 108. Temperature module (not shown) may be utilized to increase or decrease the temperature of module 506 and/or at least one cell 106, 108. Temperature module (not shown) may be configured and dimensioned to accept a liquid with sufficient thermal conductivity. In some embodiments, temperature module (not shown) may be a cooling module. In another embodiment, temperature module (not shown) may be a heating module.

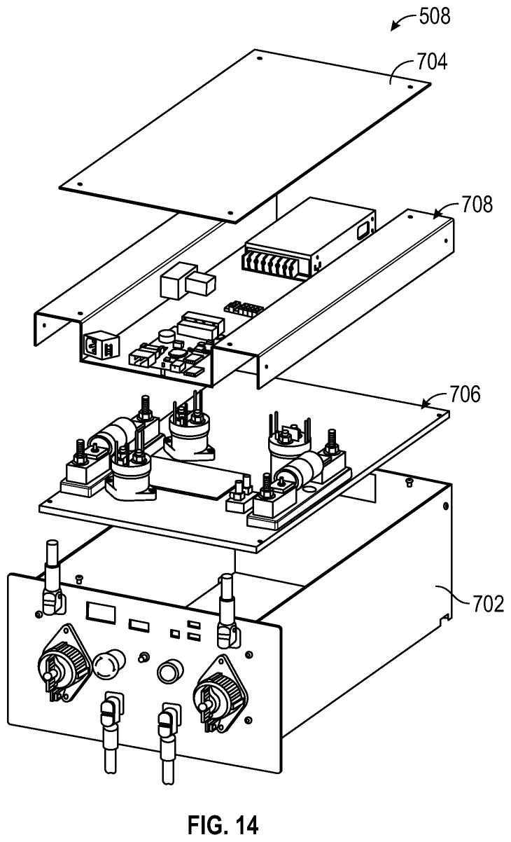

Battery rack 500 may further include at least one control module 508, as depicted in FIG. 14. Control module 508 may be positioned relative to rack assembly 502. In one embodiment, control module 508 may be positioned at the top of rack assembly 502. Control module 508 includes enclosure 702 and cover 704. Enclosure 702 and cover 704 are configured and dimensioned to encapsulate various electrical components therein. Control module 508 includes the switchgear that connects one or more battery racks to the circuit connecting to the downstream equipment, as is well known in the art. In an exemplary embodiment, high voltage components 706 and low voltage components 708 may be positioned within control module 508. High voltage components 706 may be positioned beneath low voltage components 708.

The disclosure may be embodied in other specific forms without departing from the spirit or essential characteristics thereof. The present embodiments are therefore to be considered in respects as illustrative and not restrictive.

1. A modular battery system comprising:
an enclosure defining an internal volume;
at least one module positioned within the internal volume of the enclosure; and
at least one cell positioned within the at least one module,
wherein the internal volume of the enclosure further includes at least one of (i) a supplementary cell positioned within the at least one module, (ii) a supplementary module positioned in proximity to the at least one module, or (iii) a combination of (i) and (ii).

2. The modular battery system of claim 1, wherein the at least one module comprises a plurality of cells and further comprises at least one bus bar to electrically connect the plurality of cells.

3. The modular battery system of claim 2, wherein electrical connection of the plurality of cells is selected from the group consisting of: (i) parallel connection of the plurality of cells, (ii) serial connection of the plurality of cells, and (iii) a combination of parallel and serial connections.

4. The modular battery system of claim 1, wherein the at least one module further comprises at least one supplementary cell and wherein the at least one supplementary cell performs a function selected from the group consisting of: (i) filling space within the at least one module, (ii) reducing capacity of the at least one module, (iii) reducing voltage of the at least one module, (iv) maintaining or controlling weight of the enclosure, and (v) combinations thereof.

5. The modular battery system of claim 1, wherein the enclosure is formed by or positioned within an equipment.

6. The modular battery system of claim 5, wherein the equipment is selected from the group consisting of scissor lift, boom lift, atrium lift, crane/boom truck, air compressors, air handler/chiller, tamper, vibratory compactor, roller), concrete mixing equipment, crawler, backhoe, loader, bulldozer, tractor, excavator, pressure washer, floor sweeper, floor scrubber, ice resurfacer, vacuum, floor buffer, carpet extractor, abrasive blaster, forklift, crane, winch, hoist, jack, light tower, light stand, arrow/message board, traffic signal, portable generator, stationary generator, grinder, seed spreading equipment, chipper, mower, snow blower, snow thrower, load bank; paving equipment; pumps; air conditioner; dehumidifier; heater; automobile; energy storage system, all-terrain vehicle, three-wheeler, four-wheeler, six-wheeler, utility vehicle, scooter, moped, motorcycle, boat, personal water craft, submarine, aircraft, airship, welding equipment; appliances, and any combination thereof.

7. The modular battery system of claim 1, wherein the supplementary cell is selected from the group consisting of a cooling element, a non-functional weight, a functional weight, a control system module, a shock absorbing element, a fusing and switch element, an inverter, a thermal compliance device, and any combination thereof.

8. The modular battery system of claim 1, wherein at least two modules are positioned within the internal volume of the enclosure, and wherein the at least two modules are electrically connected to each other.

9. The modular battery system of claim 1, further comprising a supplementary module positioned within the internal volume of the enclosure.

10. The modular battery system of claim 9, wherein the supplementary module is selected from the group consisting of a cooling element, a non-functional weight, a functional weight, a control system module, a shock absorbing element, a fusing and switch element, an inverter, a thermal compliance device, and any combination thereof.

11. The modular battery system of claim 1, wherein the at least one module and the at least one supplementary module are interchangeable in terms of at least one of physical geometry, mounting characteristics, electrical communication, and combinations thereof.

12. The modular battery system of claim 11, wherein removal of the at least one supplementary module does not affect the modular battery system in terms of voltage.

13. The modular battery system of claim 1, wherein the enclosure is selected from the group consisting of a pack, a rack, a polymeric container, a metal container, and any combination thereof.

14. The modular battery system of claim 1, wherein the internal volume of the enclosure further includes a supplementary cell positioned within the at least one module, and a supplementary module positioned in proximity to the at least one module.

15. The modular battery system of claim 1, wherein the battery cell is a lithium ion cell.

16. A manufacturing method for deploying lithium ion cells in an equipment requiring an energy source comprising:
providing an equipment that forms or defines a region for receipt of one or more battery cells;
deploying one or more battery cells in the region, the one or more battery cells providing sufficient energy to power the equipment;
determining a weight adjustment necessary to stabilize the equipment based in part on the weight of the one or more battery cells deployed in the region; and
deploying one or more supplementary cells within the region sufficient to provide the requisite weight.

17. A method of claim 16, wherein the at least one battery cell and the one or more supplementary cells are mounted with respect to at least one module.

18. A method of claim 17, wherein the at least one module is mounted with respect to an enclosure.

19. A method of claim 18, wherein the enclosure is selected from the group consisting of a pack, a rack, and any combination thereof.

20. A method of claim 16, wherein the supplementary cells is selected from the group consisting of a cooling element, a non-functional weight, a functional weight, a control system module, a shock absorbing element, a fusing and switch element, an inverter, a thermal compliance device, and any combination thereof.

21. A method of claim 16, wherein the equipment is selected from the group consisting of scissor lift, boom lift, atrium lift, crane/boom truck, air compressors, air handler/chiller, tamper, vibratory compactor, roller), concrete mixing equipment, crawler, backhoe, loader, bulldozer, tractor, excavator, pressure washer, floor sweeper, floor scrubber, ice resurfacer, vacuum, floor buffer, carpet extractor, abrasive blaster, forklift, crane, winch, hoist, jack, light tower, light stand, arrow/message board, traffic signal, portable generator, stationary generator, grinder, seed spreading equipment, chipper, mower, snow blower, snow thrower, load bank; paving equipment; pumps; air conditioner; dehumidifier; heater; automobile; energy storage system, all-terrain vehicle, three-wheeler, four-wheeler, six-wheeler, utility vehicle, scooter, moped, motorcycle, boat, personal water craft, submarine, aircraft, airship, welding equipment; appliances, and any combination thereof.
